(19) United States
(12) Patent Application Publication
(10) Pub. No.: US 2025/0347562 A1
(43) Pub. Date: Nov. 13, 2025

(54) SYSTEM AND METHOD FOR OCCUPANCY ESTIMATION

(71) Applicant: Delta Intelligent Building Technologies (Canada) Inc., Surrey (CA)

(72) Inventors: Dmitri Jude De Vaz, Surrey (CA); Robert Christopher Kwong, Coquitlam (CA); Gamal Kazim Mustapha, Surrey (CA)

(21) Appl. No.: 19/225,694

(22) Filed: Jun. 2, 2025

Related U.S. Application Data
(63) Continuation of application No. 17/503,891, filed on Oct. 18, 2021.
(60) Provisional application No. 63/093,533, filed on Oct. 19, 2020.

(51) Int. Cl. G01J 5/00; G01V 8/10; G06V 10/40; G06V 20/52; G06V 40/20

(52) U.S. Cl. CPC G01J 5/0025; G01V 8/10; G06V 10/40; G06V 20/53; G06V 40/20

(57) ABSTRACT

An occupancy estimation system is provided. The occupancy estimation system is configured to estimate a number of occupants in a target space. The occupancy estimation system includes a PIR motion sensor and a control apparatus. The PIR motion sensor is with a field of view of an area where occupants are expected to be present, and the PIR motion sensor is adapted to output a PIR signal. The control apparatus is adapted to receive the PIR signal to compile an aggregate of the minor and major motion behaviors of the occupants in the field of view and generate an occupancy estimation count accordingly.

### CROSS-REFERENCE TO RELATED APPLICATION

This application is a Continuation application of U.S. patent application Ser. No. 17/503,891 filed on Oct. 18, 2021 and entitled “PIR OCCUPANCY ESTIMATION SYSTEM”, which claims the benefit of U.S. Provisional Application No. 63/093,533 filed on Oct. 19, 2020, entitled “PIR OCCUPANCY ESTIMATION SYSTEM”. The entire contents of the above-mentioned patent applications are incorporated herein by reference for all purposes.

### FIELD OF THE INVENTION

The present disclosure relates to an occupancy estimation system, and more particularly to a PIR (passive infrared) occupancy estimation system.

### BACKGROUND OF THE INVENTION

An IoT (Internet of Things) connected device may be equipped with multiple integrated sensors used for monitoring and reporting the conditions of an indoor space to the Building Automation System (BAS). One of the most important inputs for control of the BAS is occupancy, as the BAS controls adjust the heating/cooling and airflow based on the occupancy of an indoor space. Knowing details of the occupied space in terms of the level of occupancy provides information related to the thermal load used for fine tuning the control system as well as the ability to provide analytics required for space utilization.

People counting technologies such as visible light cameras, thermal imaging, LIDAR (light detection and ranging), and millimeter wave detection systems are available to detect and count the number of people present in an occupied space. However, these technologies are expensive and as a result are used sparingly and only under unique circumstances.

Therefore, there is a need of providing a PIR occupancy estimation system to obviate the drawbacks encountered from the prior arts.

### SUMMARY OF THE INVENTION

It is an objective of the present disclosure to provide a PIR occupancy estimation system using a standard low-cost PIR motion sensor to produce an estimation of the number of occupants in a target space. Consequently, the cost is greatly reduced.

In accordance with an aspect of the present disclosure, there is provided an occupancy estimation system. The occupancy estimation system is configured to estimate a number of occupants in a target space. The occupancy estimation system includes a PIR motion sensor and a control apparatus. The PIR motion sensor is with a field of view of an area where occupants are expected to be present, and the PIR motion sensor is adapted to output a PIR signal. The control apparatus is in communication with the PIR motion sensor and includes a pre-processor, a feature extraction and inference unit, and a post-processor. The control apparatus is configured to: receive the PIR signal from the PIR motion sensor through the pre-processor; sample the PIR signal through the pre-processor; filter the PIR signal through the pre-processor; break the PIR signal into a plurality of frames through the pre-processor; perform a transformation, including a time-frequency transformation or a feature extract transformation, on the plurality of frames through the feature extraction and inference unit; extract statistical features from each of the plurality of frames and concatenate the statistical features into a feature vector through the feature extraction and inference unit; utilize a machine learning model to estimate the number of occupants in the target space and generate a first estimation according to the feature vector through the feature extraction and inference unit; process the first estimation from the machine learning model through a stability and smoothing phase to generate second estimations through the post-processor; and generate the occupancy estimation count through binning the second estimations through the post-processor. The time-frequency transformation includes a fast fourier transform (FFT) or a discrete wavelet transform (DWT), and the feature extracting transformation includes a random convolutional kernel transform.

In accordance with another aspect of the present disclosure, there is provided an occupancy estimation method. The occupancy estimation method is adapted to an occupancy estimation system including a PIR motion sensor with a field of view of an area where occupants are expected to be present, and adapted to output a PIR signal; and a control apparatus configured to receive the PIR signal, process the PIR signal, and estimate the number of occupants. The control apparatus includes a pre-processor, a feature extraction and inference unit, and a post-processor. The occupancy estimation method includes steps of: receiving the PIR signal from the PIR motion sensor through the pre-processor; sampling the PIR signal through the pre-processor; filtering the PIR signal through the pre-processor; breaking the PIR signal into a plurality of frames through the pre-processor; performing a transformation, including a time-frequency transformation or a feature extracting transformation, on the plurality of frames through the feature extraction and inference unit; extracting statistical features from each of the plurality of frames and concatenating the statistical features into a feature vector through the feature extraction and inference unit; utilizing a machine learning model to estimate the number of occupants in the target space and generating a first estimation according to the feature vector through the feature extraction and inference unit; processing the first estimation from the machine learning model through a stability and smoothing phase to generate second estimations through the post-processor; and generating the occupancy estimation count through binning the second estimations through the post-processor. The time-frequency transformation includes a fast fourier transform (FFT) or a discrete wavelet transform (DWT), and the feature extracting transformation includes a random convolutional kernel transform.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic block diagram illustrating a PIR occupancy estimation system according to an embodiment of the present disclosure;

FIG. 2 is a schematic block diagram showing the algorithm operated by the control apparatus to process the PIR signal;

FIG. 3 and FIG. 4 are schematic diagrams of utilizing the LSP model to process the PIR signal;

FIG. 5 and FIG. 6 are schematic diagrams of utilizing the DWT model to process the PIR signal;

FIG. 7 and FIG. 8 are schematic block diagrams showing variants of the PIR occupancy estimation system of FIG. 1;

FIG. 9 is a schematic flow chart illustrating HVAC application employing the PIR occupancy estimation system; and

FIG. 10 schematically shows additional sensors working in conjunction with the PIR motion sensor.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

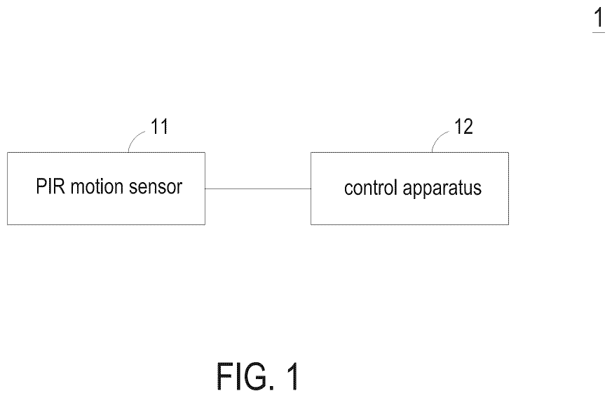

FIG. 1 is a schematic block diagram illustrating a PIR occupancy estimation system according to an embodiment of the present disclosure. As shown in FIG. 1, the PIR occupancy estimation system 1 is configured to estimate a number of occupants in a target space, and the PIR occupancy estimation system 1 includes a PIR motion sensor 11 and a control apparatus 12. Preferably but not exclusively, the target space is an indoor space. The PIR motion sensor 11 is with a field of view of an area where occupants are expected to be present, and the PIR motion sensor 11 is adapted to generate a PIR signal which includes raw PIR data. The control apparatus 12 is adapted to receive the PIR signal outputted by the PIR motion sensor 11 to compile an aggregate of minor and major motion behaviors of the occupants in the field of view and generate an occupancy estimation count accordingly. In one embodiment, the control apparatus 12 is adapted to compile an aggregate of all the minor and major motion behaviors of the occupants in the field of view and generate the occupancy estimation count accordingly. On the other hand, the control apparatus 12 is adapted to generate the occupancy estimation count based on operating an algorithm to process the raw PIR data included by the PIR signal from the PIR motion sensor 11. In an embodiment, the algorithm may be performed by a microcontroller unit (not shown) of the control apparatus 12.

Therefore, the PIR occupancy estimation system 1 of the present disclosure may utilize a standard low-cost PIR motion sensor 11 to produce an estimation of the number of occupants in a target space. Consequently, the cost is greatly reduced.

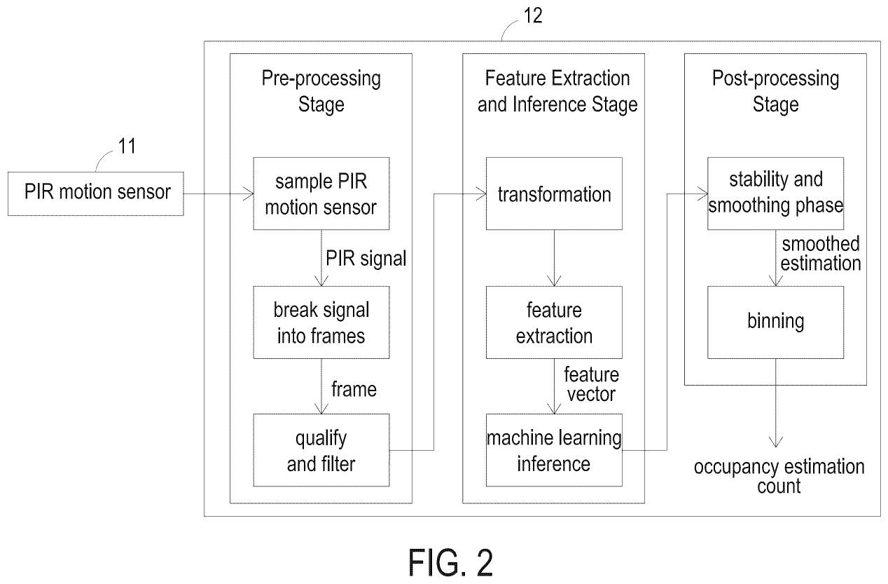

Please refer to FIG. 2. In one embodiment, the algorithm operated to process the PIR signal (i.e., processing the raw PIR data) is divided into three main stages including a pre-processing stage, a features extraction and inference stage, and a post-processing stage.

Firstly, in the pre-processing stage, the PIR signal from the PIR motion sensor 11 is sampled, and the sampling frequency is for example but not limited to 50 Hz. Depending on actual application, a bandpass filter may be utilized to filter the PIR signal to remove unwanted bias and high frequency noise, wherein the bias might be DC bias. The PIR signal is broken into multiple smaller frames, and the frame length is a parameter of the algorithm and is able to be adjusted according to actual requirements. Preferably but not exclusively, the frames are generated with a 50% overlap. The algorithm qualifies and filters the frames for minor motion.

Then, in the feature extraction and inference stage, a transformation, such as a time-frequency transformation (e.g., fast fourier transform (FFT) or discrete wavelet transform (DWT)) or a feature extracting transformation (e.g., random convolutional kernel transform), is performed on the frames. During the transformation, a 1-dimensional time series is transformed into several time series, where each time series has a different bandwidth (i.e., each signal focuses on a different part of the frequency domain). Afterwards, a collection of the frames including the output of the transformation along with the unmodified frames from the pre-processing stage is passed through a feature extraction step. In the features extraction step, several statistical features are extracted from each frame and then concatenated into a 1-dimensional feature vector. The particular features used make a large difference on whether or not the algorithm can decipher the difference between the number of occupants in the target space. The features extracted from each frame includes at least one of a Laplace spread parameter (LSP), a range between the smallest and largest samples in the frame, a zero crossing rate, a mean crossing rate, an entropy, a motion count, percent positive values (ppv), percentiles, and a slope representing the linear trend of the signal, but not limited thereto. Then, the feature vector is passed on to the machine learning (ML) model for inference. The relevant information has been extracted into features that the machine learning model may use to estimate the number of occupants. According to the feature vector, the machine learning model outputs an approximate estimation for the number of occupants.

In an embodiment, during pre-processing stage and the feature extraction and inference stage, the algorithm is adapted to distinguish and characterize the frames between major motion and minor motion, where the major motion is discarded and the minor motion is saved for further processing. Namely, the algorithm extracts the frame where the minor motion detected.

Finally, in the post-processing stage, the algorithm processes the approximate estimations outputted from the machine learning model through a generic temporal stability and smoothing phase to generate smoothed estimations for the number of occupants. For example, in the stability and smoothing phase, the approximate estimations are processed through a low pass filter, a Kalman filter, a hidden Markov model, or a simple state machine to generate the smoothed estimations, but not limited to. Through binning the smoothed estimations, the final occupancy estimation counts are generated accordingly. In an embodiment, a supervisory logic is applied to the approximate or smoothed estimations to eliminate anomalies and edge cases.

Consequently, the PIR occupancy estimation system 1 of the present disclosure processes the PIR signal by using a combination of signal processing and machine learning techniques.

Depending on the environment and types of motion produced by occupants, the algorithm operated by the control apparatus 12 may use different models to process the PIR signal (i.e., process the raw PIR data). The LSP model and the DWT model and the corresponding processing steps are exemplified as follows.

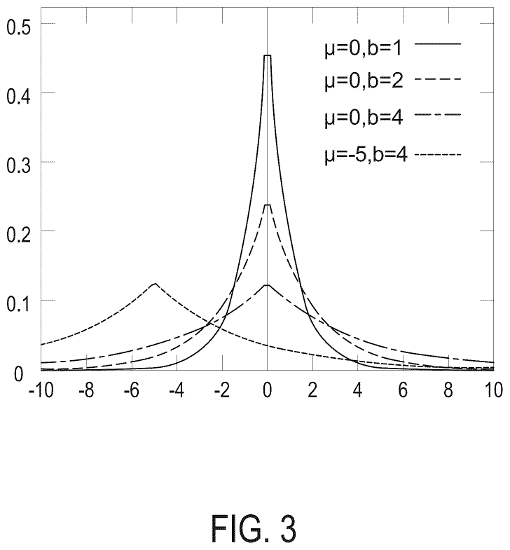

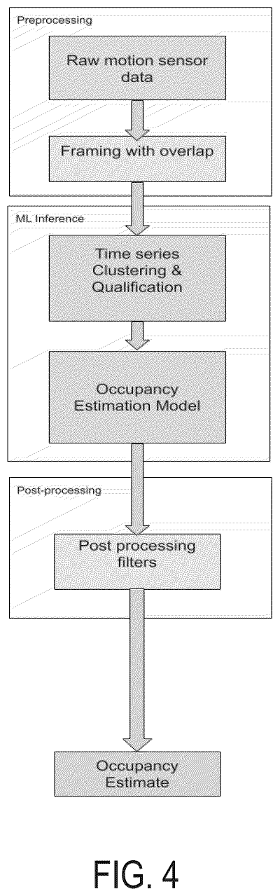

Please refer to FIG. 3 and FIG. 4. As shown in FIG. 3, the LSP model works by combining a DSP (digital signal processing) pipeline to remove noise before qualifying and statistically modeling the distribution of key parameters. Modeling the signal using a Laplace distribution is configured for making this model work correctly. As shown in FIG. 4, when the LSP model is applied, the following steps are performed to process the PIR signal:
1. A bandpass filter is applied to the PIR signal (analog data) from the PIR motion sensor 11 in order to remove unwanted DC bias and high frequency noise;
2. The signal outputted by the bandpass filter is windowed and framed with 50% overlap;
3. Each frame is analyzed by an unsupervised/clustering machine learning model to distinguish between major motion and minor motion;
4. The major motion is discarded, and the minor motion is fed to a model to calculate the Laplace spread parameter (LSP);
5. The resulting LSP is then passed through a low pass filter to increase stability, wherein the LSP is fed to a machine learning model to get an approximate estimation for the number of occupants;
6. A supervisory logic is applied to the approximate estimations to identify and eliminate anomalies and edge cases; and
7. The final occupancy count estimation is then allocated to an occupancy group and is ready for use by the BAS.

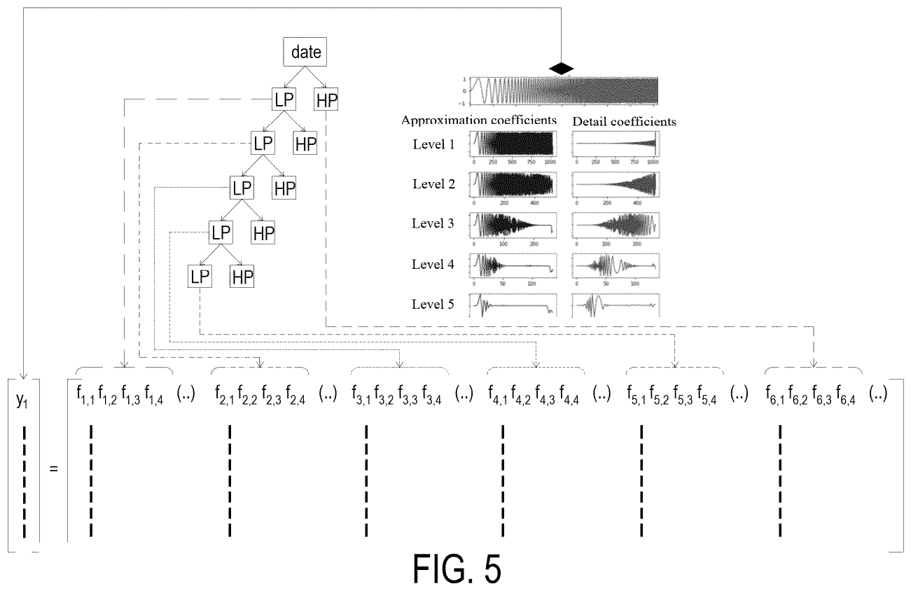

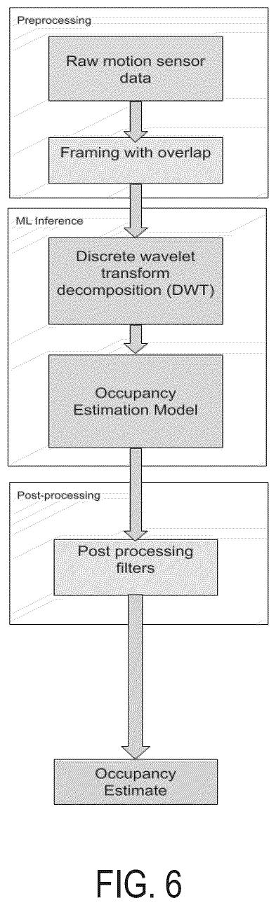

Please refer to FIG. 5 and FIG. 6. FIG. 5 schematically shows the architecture of the DWT model. As shown in FIG. 6, when the DWT model is applied, the following steps are performed to process the PIR signal:
1. A bandpass filter is applied to the PIR signal (analog data) from the PIR motion sensor 11 in order to remove unwanted DC bias and high frequency noise;
2. The signal outputted by the bandpass filter is windowed and framed with 50% overlap;
3. A discrete wavelet transform (DWT) is applied to the filtered signal where it is passed through a bank of filters with carefully chosen cut-off frequencies;
4. The result of the DWT is several signals of varying bandwidths. Basic statistics are pulled out of each feature and concatenated into a feature vector;
5. The feature vector is than passed to the machine learning model to generate a candidate occupancy count;
6. The resulting candidate occupancy count is passed through a low pass filter to increase stability;
7. The filtered occupancy count is post-processed using the time history of previous generated occupancy counts; and
8. The final occupancy count estimation is then allocated to an occupancy group and is ready for use by the BAS.

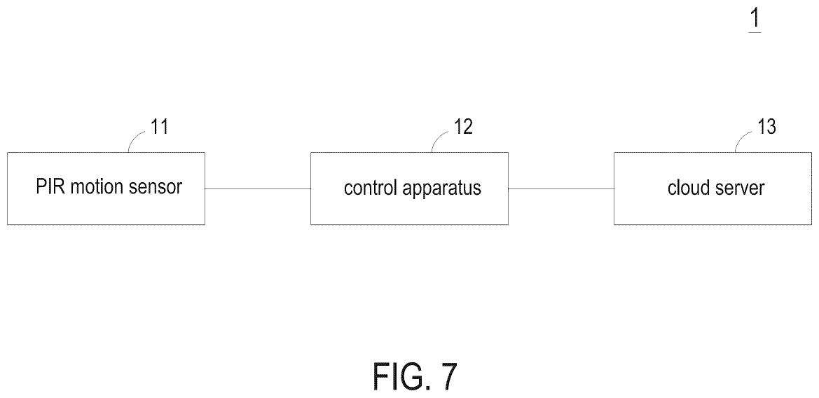

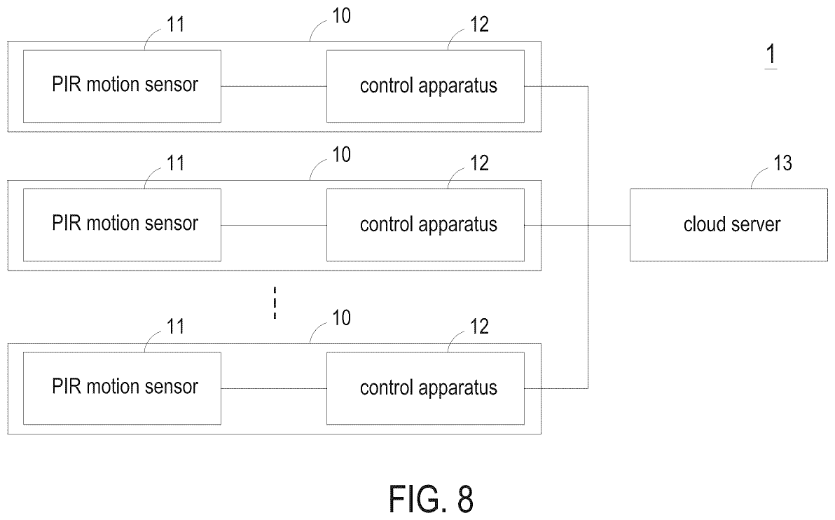

In an embodiment, as shown in FIG. 7, the PIR occupancy estimation system 1 further includes a cloud server 13 adapted to store the data, and the control apparatus 12 includes a transceiver (not shown) corresponding. The transceiver is in communication with the cloud server 13, and is configured to transmit the data or signals to the data collection server or to receive the data or signals stored in the data collection server. In an embodiment, as shown in FIG. 8, the PIR motion sensor 11 and the control apparatus 12 form an occupancy estimation unit 10, and the PIR occupancy estimation system 1 may include a plurality of said occupancy estimation units 10 all in communication with the cloud server 13. Therefore, the plurality of occupancy estimation units 10 may be used to estimate the number of occupants in plural target spaces, and the operation of occupancy estimation units 10 may be monitored and controlled through the cloud server 13.

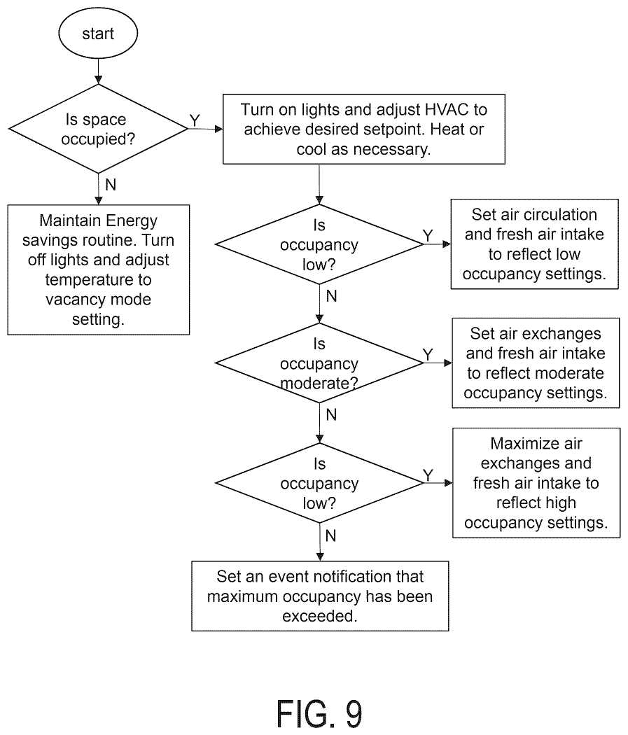

The PIR occupancy estimation system 1 of the present disclosure may be applied in applications like space utilization analytics, monitoring and controlling occupancy in an indoor space and optimizing HVAC (heating, ventilation and air conditioning) control/energy, but not limited thereto. Taking HVAC applications as an example, FIG. 9 shows the corresponding flow chart. Based on the number of occupants from the PIR occupancy estimation system 1, the HVAC system may be manipulated by the controller thereof to maximize energy efficiency and maintain optimal occupant comfort. It is noted that the steps in the flow chart of FIG. 9 are performed by the controller of the HVAC system. As shown in FIG. 9, firstly, whether the target space is occupied is determined. If the target space is not occupied, the energy savings routine is maintained. In particular, the lights are turned off, and the temperature is adjusted to vacancy mode setting. Whereas, if the target space is occupied, the lights are turned on, the HVAC system is adjusted to achieve desired setpoint, and heating or cooling is taken as necessary. Afterwards, the level of the occupancy is determined through judging whether the occupancy is low, moderate or high, so as to manipulate the HVAC system accordingly. If the occupancy is low, the air circulation and fresh air intake are set to reflect low occupancy settings. If the occupancy is moderate, the air exchanges and fresh air intake are set to reflect moderate occupancy settings. If the occupancy is high, the air exchanges and fresh air intake are maximized to reflect high occupancy settings. The low, moderate, and high occupancy settings depend on the size and air volume capacity of the target space. Further, if the results of judging whether the occupancy is low, moderate or high are all not satisfied, an event notification that maximum occupancy has been exceeded is set. In addition, room utilization is able to be recorded over time, and the HVAC system is able to predict settings and pre-heat/pre-cool prior to utilization, and the room utilization tracking and reporting are also useful for optimizing building performance.

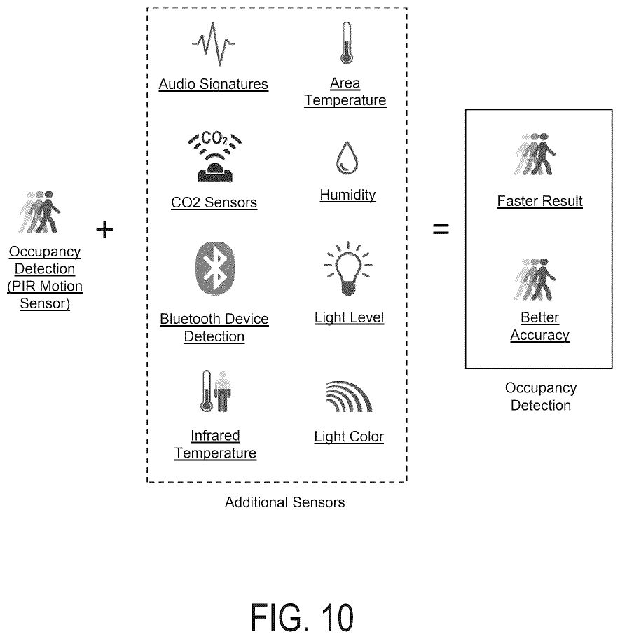

In an embodiment, the PIR occupancy estimation system 1 includes a plurality of said PIR motion sensors 11 to refine and/or enhance the readings recorded by the motion sensors. As an example, the adjacent distributed PIR motion sensors are utilized to detect motion coming or leaving other spaces. Further, in an embodiment, as shown in FIG. 10, in addition to the PIR motion sensor, the PIR occupancy estimation system 1 further includes various kinds of additional sensors to realize sensor fusion. Correspondingly, the PIR occupancy estimation system 1 may further include a sensor hub (not shown) for processing signals from the sensors. The additional sensors both housed within the same device or from other devices on the same network are able to work together with the PIR motion sensor to produce a more rapid and more accurate occupancy estimate count of the target space. For example, the additional sensors includes at least one of an audio sensor, a CO2 sensor, a Bluetooth device sensor, an infrared temperature sensor, an area temperature sensor, a humidity sensor, a light level sensor, and a light color sensor, but not limited thereto. The audio sensor is adapted to detect the audio signatures reflecting the amount of noise above normal noise floor, which is an indication of people. The CO2 sensor is adapted to detect people based on CO2 level. The Bluetooth device sensor is adapted to detect number of Bluetooth devices. The infrared temperature sensor is adapted to detect thermal loads from people. Consequently, the additional sensors is adapted to give a different aspect of occupancy under specific circumstances, and these additional sensors working in conjunction with the PIR motion sensor would improve the occupancy detection speed and accuracy.

From the above descriptions, the present disclosure provides a PIR occupancy estimation system using a standard low-cost PIR motion sensor to produce an estimation of the number of occupants in a target space. This is made possible by processing the PIR signal using a combination of signal processing and machine learning techniques. Consequently, the cost is greatly reduced.

While the disclosure has been described in terms of what is presently considered to be the most practical and preferred embodiments, it is to be understood that the disclosure needs not be limited to the disclosed embodiment.

What is claimed is:

1. A PIR occupancy estimation system, configured to estimate a number of occupants in a target space, and comprising:
a PIR motion sensor with a field of view of an area where occupants are expected to be present, and adapted to output a PIR signal; and
a control apparatus, in communication with the PIR motion sensor, the control apparatus comprising a pre-processor, a feature extraction and inference unit, and a post-processor, and configured to:
receive the PIR signal from the PIR motion sensor through the pre-processor;
sample the PIR signal through the pre-processor;
filter the PIR signal through the pre-processor;
break the PIR signal into a plurality of frames through the pre-processor;
perform a transformation, comprising a time-frequency transformation or a feature extract transformation, on the plurality of frames through the feature extraction and inference unit;
extract statistical features from each of the plurality of frames and concatenate the statistical features into a feature vector through the feature extraction and inference unit;
utilize a machine learning model to estimate the number of occupants in the target space and generate a first estimation according to the feature vector through the feature extraction and inference unit;
process the first estimation from the machine learning model through a stability and smoothing phase to generate second estimations through the post-processor; and
generate the occupancy estimation count through binning the second estimations through the post-processor,
wherein the time-frequency transformation comprises a fast fourier transform (FFT) or a discrete wavelet transform (DWT), and the feature extracting transformation comprises a random convolutional kernel transform.

2. The PIR occupancy estimation system according to claim 1, wherein the control apparatus is configured to utilize a bandpass filter to filter the PIR signal and remove unwanted bias and high frequency noise.

3. The PIR occupancy estimation system according to claim 1, wherein the control apparatus is configured to break the PIR signal into the plurality of frames with a 50% overlap through the pre-processor.

4. The PIR occupancy estimation system according to claim 1, wherein the statistical features comprise at least one of a Laplace spread parameter, a range between the smallest and largest samples in the frame, a zero crossing rate, a mean crossing rate, an entropy, a motion count, percent positive values, percentiles, and a slope.

5. The PIR occupancy estimation system according to claim 1, wherein the control apparatus is adapted to distinguish and characterize the plurality of frames between minor and major motion behaviors of the occupants in the field of view of the plurality of frames, and extracts the frame where the minor motion behaviors detected.

6. The PIR occupancy estimation system according to claim 1, wherein the control apparatus is adapted to apply a supervisory logic to the approximate or smoothed estimations to eliminate anomalies and edge cases.

7. The PIR occupancy estimation system according to claim 1, further comprising a cloud server adapted to store data, wherein the control apparatus further comprises a transceiver in communication with the cloud server.

8. The PIR occupancy estimation system according to claim 7, wherein the PIR motion sensor and the control apparatus form an occupancy estimation unit, and the PIR occupancy estimation system comprises a plurality of the occupancy estimation units which are all in communication with the cloud server.

9. The PIR occupancy estimation system according to claim 1, further comprising a plurality of additional sensors, comprising at least one of an audio sensor, a CO2 sensor, a Bluetooth device sensor, an infrared temperature sensor, an area temperature sensor, a humidity sensor, a light level sensor, and a light color sensor, working in conjunction with the PIR motion sensor.

10. An occupancy estimation method adapted to an occupancy estimation system comprising a PIR motion sensor with a field of view of an area where occupants are expected to be present, and adapted to output a PIR signal; and a control apparatus configured to receive the PIR signal, process the PIR signal, and estimate the number of occupants, wherein the control apparatus comprises a pre-processor, a feature extraction and inference unit, and a post-processor, wherein the occupancy estimation method comprises steps of:
receiving the PIR signal from the PIR motion sensor through the pre-processor;
sampling the PIR signal through the pre-processor;
filtering the PIR signal through the pre-processor;
breaking the PIR signal into a plurality of frames through the pre-processor;
performing a transformation, comprising a time-frequency transformation or a feature extracting transformation, on the plurality of frames through the feature extraction and inference unit;
extracting statistical features from each of the plurality of frames and concatenating the statistical features into a feature vector through the feature extraction and inference unit;
utilizing a machine learning model to estimate the number of occupants in the target space and generating a first estimation according to the feature vector through the feature extraction and inference unit;
processing the first estimation from the machine learning model through a stability and smoothing phase to generate second estimations through the post-processor; and
generating the occupancy estimation count through binning the second estimations through the post-processor,
wherein the time-frequency transformation comprises a fast fourier transform (FFT) or a discrete wavelet transform (DWT), and the feature extracting transformation comprises a random convolutional kernel transform.

11. The occupancy estimation method according to claim 10, further comprising a step of: utilizing a bandpass filter to filter the PIR signal and to remove unwanted bias and high frequency noise in the step of filtering the PIR signal.

12. The occupancy estimation method according to claim 10, further comprising a step of: distinguishing and characterizing the plurality of frames between minor and major motion behaviors of the occupants in the field of view of the plurality of frames, and extracting the frame where the minor motion behaviors detected.

13. The occupancy estimation method according to claim 10, further comprising a step of: applying a supervisory logic to the approximate or smoothed estimations to eliminate anomalies and edge cases.

14. A system configured to estimate a number of occupants in a target space, the system comprising:
a PIR motion sensor having a field of view of an area where occupants are expected to be present and configured to output a PIR signal; and
a control apparatus configured to receive the PIR signal, compile an aggregate of minor and major motion behaviors of the occupants in the field of view, and generate an occupancy estimation count based on the minor motion behavior,
wherein the control apparatus is configured to break the PIR signal into a plurality of frames and perform a time-frequency transformation or a feature-extraction transformation on the plurality of frames,
wherein the control apparatus is further configured to analyze each of the plurality of frames using an unsupervised or clustering machine learning model to distinguish between the minor and major motion behaviors, with the major motion behavior being discarded,
and wherein the control apparatus is further configured to apply a bandpass filter to the PIR signal to remove unwanted bias and high-frequency noise.

15. The system according to claim 14, wherein the control apparatus is configured to break the PIR signal into the plurality of frames with a 50% overlap.

16. The system according to claim 14, wherein the control apparatus is configured to extract statistical features from each of the plurality of frames and concatenate the statistical features into a feature vector, based on the plurality of frames and an output of the transformation for each of the plurality of frames, the statistical features comprising at least one of a Laplace spread parameter, a range between smallest and largest samples in the frame, a zero crossing rate, a mean crossing rate, an entropy, a motion count, percent positive values, percentiles, and a slope.

17. The system according to claim 16, wherein the control apparatus is configured to distinguish and characterize the plurality of frames between the major and minor motion behaviors and to extract the frame where the minor motion behavior is detected.

18. The system according to claim 16, wherein the control apparatus is further configured to utilize a machine learning model to estimate the number of occupants in the target space based on the feature vector and generate an approximate estimation, and wherein the control apparatus is further configured to process the approximate estimations through a stability and smoothing phase to generate smoothed estimations and to generate the occupancy estimation count by binning the smoothed estimations.

19. The system according to claim 18, wherein the control apparatus is further configured to apply supervisory logic to the approximate or smoothed estimations to eliminate anomalies and edge cases.

20. The system according to claim 14, further comprising at least one of an audio sensor, a CO2 sensor, a Bluetooth device sensor, an infrared temperature sensor, an area temperature sensor, a humidity sensor, a light level sensor, and a light color sensor, each working in conjunction with the PIR motion sensor; and further comprising a cloud server configured to store data, wherein the control apparatus comprises a transceiver in communication with the cloud server, and wherein the system comprises a plurality of occupancy estimation units, each including a PIR motion sensor and a control apparatus in communication with the cloud server.
